(19) United States
(12) Patent Application Publication
(10) Pub. No.: US 2025/0045386 A1
(43) Pub. Date: Feb. 6, 2025

(54) DETECTION AND MITIGATION OF CYBER ATTACKS ON AIMED AT VEHICLE'S DIAGNOSTIC SESSIONS

(71) Applicant: Red Bend Ltd., Hod Hasharon (IL)

(72) Inventor: Arie Ben Zvi, Caesarea (IL)

(21) Appl. No.: 18/715,041

(22) PCT Filed: Dec. 2, 2021
(86) PCT No.: PCT/IL2021/051439

§ 371 Date: May 30, 2024

(51) Int. Cl. G06F 21/55; B60R 16/023

(52) U.S. Cl. CPC G06F 21/554; B60R 16/0232; G06F 2221/034

(57) ABSTRACT

The disclosure is of a device and a method of securing machinery supporting controller area network protocol from diagnostics based attacks, by enforcing a diagnostic policy mapping diagnostics requests and their sub-function to associated vehicle states, for example by using a table of diagnostic function identifiers and associated valid vehicle states. When a diagnostic request and Sub-Function are marked valid for the vehicle state, the diagnostic operation is valid. When a diagnostic request and Sub-Function are marked not valid for the vehicle state, the diagnostic operation is not valid, and aborted.

### FIELD AND BACKGROUND OF THE DISCLOSURE

The present disclosure, in some embodiments thereof, relates to cyber-attack mitigation, and, more particularly, but not exclusively, detection and mitigations of diagnostic cyber-attacks on vehicles.

Modern machinery, including vehicles, industrial machinery, critical infrastructure facilities, and the like, may comprise many electrically controllable and optionally reprogrammable components. These components may be computerized, based on a programmable controller, on application specific circuits, and/or the like.

A modern vehicle, for example, may have as many as 70 Electronic Control Units (ECUs) for controlling various subsystems, obtaining metrics therefrom, and/or the like.

Some of these ECUs form independent subsystems, however communications among other ECUs may be essential for the machinery operation. The Controller Area Network (CAN) standard was developed to support these requirements.

A CAN bus is a robust vehicle bus standard designed to allow ECUs to communicate with each other's applications. It is a broadcast messaged based protocol with a unique identifier for each frame. Frames are received by all devices, including by the transmitting device.

The CAN bus supports a Diagnostic standard that ECUs may support, namely Unified Diagnostic Services (UDS). UDS is a diagnostics communication protocol that enables to read/write data to/from ECU's, Read and clear error codes, read/write configuration, upload, reprogram software and other controls.

An On-Board Diagnostic (OBD) connector, or (OBD-II) is a standard connector that enables external diagnostic tools to connect to the vehicle CAN bus for diagnostics sessions.

For purposes of better understanding some embodiments of the present disclosure, some details about the CAN bus are introduced:

Several layers of the CAN bus may be involved in diagnostics session. The models according to ISO/IEC 7498-1 and ISO/IEC 10731 include seven layers.

Layers 1 & 2 are CAN physical and CAN driver layer accordingly, as in ISO 11898, ISO-1199201 and/or SAE J1939-15. Layer 3 defines the CAN network management. Transport layer, layer 4, is ISO-TP. The session layer is one layer underneath the UDS application layer which default the different possible session. Layer 7 the application is the UDS. Applicable standards include ISO 15765-2, ISO 15765-3, ISO 11992-4 and ISO 14229.

The term Controller Area Network, (CAN), may refer to a controller network with a frame-based protocol, for communication between devices without a host computer. CAN may further provide a multi-master redundant network, operating even if some of the nodes are not functioning. CAN frames are not necessarily associated with a recipient address but are classified over their identifier. As a consequence, CAN controllers may broadcast their frames to all connected nodes, when all connected nodes decide independently whether to further process the received frames. CAN communication may apply a decentralized priority driven access control methods to guarantee the transmission of a top priority frame first and an error detecting mechanism that can detect errors and interrupt communication. Further the term CAN may include, but is not necessarily limited to, event triggered CAN bus, time triggered CAN bus, multimedia connected CAN bus, wireless connected CAN bus, a local small autonomous network such as local interconnected network (LIN) bus, or additional communication protocols sharing the multicast or broadcast features and supporting similar diagnostic protocol.

Each message sent between two network devices may be subdivided into packets comprising units of binary data being communicated through a computer network by the underlying hardware and software. Depending on the protocol, packets may be constructed in some standard format determining their boundaries, origin and destination. Packets may be encapsulated into frames in the data link layer so that they can be transferred over different media to the end destination. The term frame may interchangeably refers hereinafter to a message format that is communicated in a CAN network. This includes, for example, both the base frame format (11 bits ID) and the extended frame format (29 bits ID made up of the 11-bit identifier (base identifier) and an 18-bit extension (identifier extension). Additionally or alternatively, the term may further include one or more of the following frame types: data frame: a frame containing node data for transmission; remote frame: a frame requesting the transmission of a specific identifier; error frame: a frame transmitted by any node detecting an error; and, overload frame: a frame to inject a delay between data and/or remote frame.

Error in a CAN network may occur in the bit level and/or at the frame level. These errors may include, for example, cyclic redundancy check (CRC), bit error, bit stuffing, monitoring, frame, and acknowledgement errors. When an ECU detects an error, it may immediately abort the transmission and broadcast an error frame including an error flag made up of a bit string that violates the bit stuffing rule, all other ECUs will respond by transmitting error flags too. Following a sufficient number of errors, an ECU will eventually switch to bus off state.

Errors may be divided into transmission errors and receiving errors. In machinery such as a vehicle it may be vital to know whether the errors are transient (such as due to noise, electrical surges, or any temporary condition) or permanent due to failure of the node due to defective hardware. Consequently, each node or ECU includes one or more error counters, keeping track of the number of errors transmitted and received. Typically, the error count can affect the status of the ECU as follows:

Each ECU node may be operating, according to the CAN bus definition, to operate in one of the three states: error active, error passive and bus off. The terms active and/or passive may refer to the type of error frame that the node is allowed to send if it had detected an error. An error active status indicates that the node is fully functional. The node is active on the network and can transmit Error Active frames. When the node is in Error Active state then whenever it detects an error it can interrupt the transmission by sending an Error Active frame. An Error Active frame comprises six dominant (i.e. O's zero) bits which override what is currently being transmitted on the bus. It interrupts the current transmission and all the nodes on the bus including the transmitter are aware that an error was detected.

Unlike Error Active state, when the node is in error passive status mode, the node is restricted from sending an Error Active frames (according to the CAN bus definition). This means that if the node detects an error then it can send an Error Passive frame which consists of 6 recessive (i.e. l's) bits. Since the recessive bits do not interrupt the transmission then the transmitting node may continue its transmission without interruption. Other than the difference in the type of Error frame that the node is allowed to send, there are no additional significant differences and the node can transmit normal frames like any other node on the bus. Error counts above as a non-limiting example 255, will cause the node to enter a bus-off mode, without transmission on the bus.

Typically, received errors raise the error count by one (or another predefined number) and transmit errors raise the count by eight (or another predefined number). Error free messages lower the count by one (or another predefined number).

When the error count returns to zero normal activity is resumed. When in offline mode, a node in the bus off, offline, or compatible condition configures a predetermined number of consecutive recessive bits have been monitored. If a node detects an error while it is transmitting a normal frame (either that it detected the error by itself or some other node transmitted an Error Active frame and interrupted its transmission) it may increase the error count by 8 (TX_ERROR_COUNTER=TX_ERROR_COUNTER+8). When the error counter crosses the 127 level (128 and above) it changes from Error Active to Error Passive state. When the error counter reaches 256 then the node may be switched to Bus-Off state and is no longer allowed to transmit any messages.

When the node is not in Bus-Off then every successful transmission of a normal frame causes the error counter to be decreased by 1 (or another predefined value). This allows the node to recover back to Error Active state in case there are no recurring errors caused by this node's transmissions.

A dedicated ECU in a CAN network (MAPPER_ECU) may cause error frames deliberately by injecting Six (6) dominant bits while another ECU is transmitting a message. As described in the technical background this will cause the transmitting ECU to increase its TX_ERROR_COUNTER by Eight (8) and send an error frame to the CAN BUS.

This technique was implemented in our patent application US20180241584, named MEANS AND METHODS FOR REGULATING CAN COMMUNICATION, for disabling a malicious ECU. It was used by repeating the injection of Six (6) dominant bits for consecutive retransmissions of a message, to increase the TX_ERROR_COUNTER to 256 and change the transmitting ECU status to BUS-OFF and consequently stop it from transmitting.

An enhanced method to bring the ECU to BUS-OFF quickly by causing 32 errors of various types to occur during the first transmission and avoiding retransmission handling, was described in US20200387605, named SYSTEMS AND METHODS FOR DISABLING A MALICIOUS ECU IN A CONTROLLER AREA NETWORK (CAN) BUS.

ISO 15765-2 or ISO-TP (Transport Layer), is an international standard for sending data packets over a CAN-Bus. The protocol allows for the transport of messages that exceed the eight byte maximum payload of CAN frames. ISO-TP segments longer messages into multiple frames, adding metadata that allows the interpretation of individual frames and reassembly into a complete message packet by the recipient. It can carry up to 4095 bytes of payload per message packet.

In the OSI Model, ISO-TP covers the layer 3 (network layer) and 4 (transport layer).

A common application for ISO-TP is the transfer of diagnostic messages with OBD-2 equipped vehicles using KWP2000 and UDS, however it is also used in other application-specific CAN implementations.

ISO-TP may prepend one or more metadata bytes to the payload data in the eight byte CAN frame, reducing the payload to seven or fewer bytes per frame. The metadata may be referred to as the Protocol Control Information, or PCI. The PCI may be one, two or three bytes. The initial field may be four bits indicating the frame type, and implicitly describing the PCI length.

### SUMMARY OF THE DISCLOSURE

It is an object of the present disclosure to describe a device and a method of securing machinery supporting controller area network protocol from diagnostics based attacks, by enforcing a diagnostic policy mapping diagnostics requests and their sub-function to associated vehicle states, for example by using a table.

According to an aspect of some embodiments of the present disclosure there is provided a method of detection and mitigation of diagnostic attacks on machines comprising a vehicular communication bus, comprising:
receiving a table of diagnostic function identifiers and associated valid vehicle states; and
in response to a diagnostic request detected on the vehicular communication bus:
   extract a diagnostic function identifier from the diagnostic request; and
   when the vehicle state of the machine is not compatible with the associated valid vehicle states of the diagnostic function identifier, initiate an interfering diagnostic request.

According to an aspect of some embodiments of the present disclosure there is provided a device for detection and mitigation of diagnostic attacks on machines comprising a vehicular communication bus, comprising at least one processing circuitry configured to:
receive a table of diagnostic function identifiers and associated valid vehicle states; and
in response to a diagnostic request detected on the vehicular communication bus:
   extract a diagnostic function identifier from the diagnostic request; and
   when the vehicle state of the machine is not compatible with the associated valid vehicle states of the diagnostic function identifier, initiate an interfering diagnostic request.

According to an aspect of some embodiments of the present disclosure there is provided a computer program product comprising instructions of mitigation of diagnostic attacks on machines comprising a vehicular communication bus, wherein execution of the instructions by one or more processors of a device is to cause the device to:
receive a table of diagnostic function identifiers and associated valid vehicle states; and
in response to a diagnostic request detected on the vehicular communication bus:
   extract a diagnostic function identifier from the diagnostic request; and
   when the vehicle state of the machine is not compatible with the associated valid vehicle states of the diagnostic function identifier, initiate an interfering diagnostic request.

According to some embodiments of the disclosure, the vehicular communication bus supports a controller area network protocol, and the interfering diagnostic request is defaultSession.

According to some embodiments of the disclosure, the interfering diagnostic request is sent in response to a positive response of an electronic control unit to the first diagnostic request whose diagnostic function identifier is other than default Session.

According to some embodiments of the disclosure, the method is implemented by an electronic control unit (ECU) and applied by connecting the ECU to the communication bus.

According to some embodiments of the disclosure, the vehicle state differ between running and power off.

According to some embodiments of the disclosure, the vehicle state comprise a state, equivalent to power off.

According to some embodiments of the disclosure, the vehicle state comprise a state, equivalent to switch on without ignition.

According to some embodiments of the disclosure, the vehicle state comprise a state, equivalent stationary with engine on.

According to some embodiments of the disclosure, the vehicle state comprise a state, equivalent to running.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

Implementation of the method and/or devices of embodiments of the disclosure can involve performing or completing selected tasks manually, automatically, or a combination thereof. Moreover, according to actual instrumentation and equipment of embodiments of the method and/or system of the disclosure, several selected tasks could be implemented by hardware, by software or by firmware or by a combination thereof using an operating system.

For example, hardware for performing selected tasks according to embodiments of the disclosure could be implemented as a chip or a circuit. As software, selected tasks according to embodiments of the disclosure could be implemented as a plurality of software instructions being executed by a computer using any suitable operating system. In an exemplary embodiment of the disclosure, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the disclosure are herein described, by way of example only, with reference to the accompanying drawings and formulae. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 is a schematic illustration of an exemplary device for detection and mitigation of diagnostic attacks on machines;

FIG. 2 is a schematic illustration of an exemplary vehicular communication bus, connected to a plurality of devices, according to some embodiments of the present disclosure;

FIG. 3 is a basic flow chart of an exemplary process detection and mitigation of diagnostic attacks on machines, according to some embodiments of the present disclosure;

FIG. 4 is a table of diagnostic request of an exemplary protocol which may be vulnerable to diagnostic attacks on machines, according to prior art;

FIG. 5 is an exemplary state diagram of an aspect of an exemplary protocol which may be vulnerable to diagnostic attacks on machines, according to prior art;

FIG. 6 is an exemplary table of diagnostic function identifiers and associated valid vehicle states of an exemplary protocol which may be vulnerable to diagnostic attacks on machines, according to some embodiments of the present disclosure; and

FIG. 7 is a sequence diagram of an exemplary process of detection and mitigation of diagnostic attacks on a machine comprising a vehicular communication bus, according to some embodiments of the present disclosure.

### DESCRIPTION OF SPECIFIC EMBODIMENTS OF THE DISCLOSURE

The present disclosure, in some embodiments thereof, relates to cyber-attack mitigation, and, more particularly, but not exclusively, detection and mitigations of diagnostic cyber-attacks on vehicles.

The OBD diagnostic session, using CAN bus, may be wildly used in garage shops and repairs to diagnose issues and to update ECU's software on vehicles and other machinery.

The Diagnostic tool may be connected through the OBD connector, an alternate connector, or through wireless communication, to the vehicular communication bus and issues its diagnostics session commands.

Diagnostic sessions may also occur by ECU issuing diagnostics session and sending results to a control center (for example GM OnStar) or thru Over the Air (OTA) Update.

However the diagnostic session may also be used by an attacker to issue malicious attacks such as software updates with malicious code, modifying ECU configuration, and/or the like.

The present disclosure describes methods to detect and mitigate diagnostics sessions attacks. Diagnostics messages (UDS) are messages that are used for diagnostics sessions in the vehicle.

UDS session may be designed for when the machine is in not in normal usage, for example an industrial machine is off production, or a vehicle is at the garage and a technician connects a diagnostics computer to the vehicle.

Another mode is that internal vehicle ECU may issue diagnostics session to inspect the ECU or for example to transmit data for a base station that analyze data.

An attacker can use both options, to connect to the vehicle bus as a technician tool, or example through the OBD-II connector, or as an internal ECU connected directly to the CAN bus.

One method of detection of an attack is to define a Valid/Invalid diagnostic policy based on the diagnostic command and the vehicle state.

For example, the state of the vehicle which can be of the following mode: “Power Off”, “Switch On” (Switch ON without ignition), “Engine On” (Engine is on but not driving and the handbrake is up), and “Running” (The vehicle is moving). Industrial machine and infrastructure facilities may have states compatible therewith, or somewhat different states, related to whether some or all of the machine parts are operated or not, manual configuration, security clearance, and/or the like.

Each Diagnostic request has a sub function for a specific service, for example: The Diagnostic session may have sub-functions to change to other session such as programming, extended diagnostics, and safety system diagnostics sessions. The Security Access request may have sub-functions to access to Programmable memory, Key learning, VIN write, Special Functions, and the like.

The Valid/Invalid diagnostic policy may map diagnostics requests and their sub-function to associated vehicle states, for example by using a table of diagnostic function identifiers and associated valid vehicle states.

When a diagnostic request and Sub-Function are marked valid for the vehicle state, the diagnostic operation is valid.

When a diagnostic request and Sub-Function are marked not valid (Invalid) for the vehicle state, the diagnostic operation is not valid.

Detection and Mitigation of diagnostics attacks on vehicle may be used for protecting vehicle ECU's from harmful, malicious operations, and to verify that a diagnostic operation is done in a safe and appropriate mode. For example, that no updates to ECU's are done during driving (running state).

The disclosure may also be used by OEM to prevent attacker ECU to harm other ECU's, by maintenance facilitators such as garages to tests whether an diagnostics tools operates correctly, and by the OEM to get information to their control center on diagnostics alerts and information on attacks.

Before explaining at least one embodiment of the disclosure in detail, it is to be understood that the disclosure is not necessarily limited in its application to the details of instructions and the arrangement of the components and/or methods set forth in the following description and/or illustrated in the drawings and/or the Examples. The disclosure is capable of other embodiments or of being practiced or carried out in various ways.

Embodiments may be a device, a method, and/or a computer program product. The computer program product may include a computer readable storage medium (or media) having computer readable program instructions thereon for causing a processor to carry out aspects of the embodiments.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a remote web or cloud service, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including a scripting language such as Python or Perl, an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

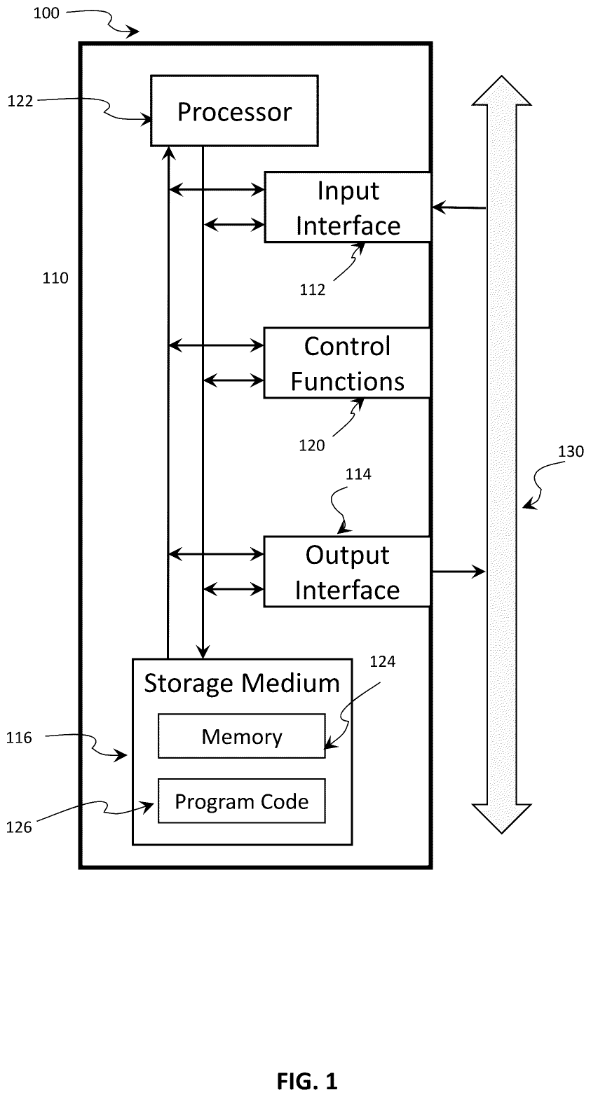

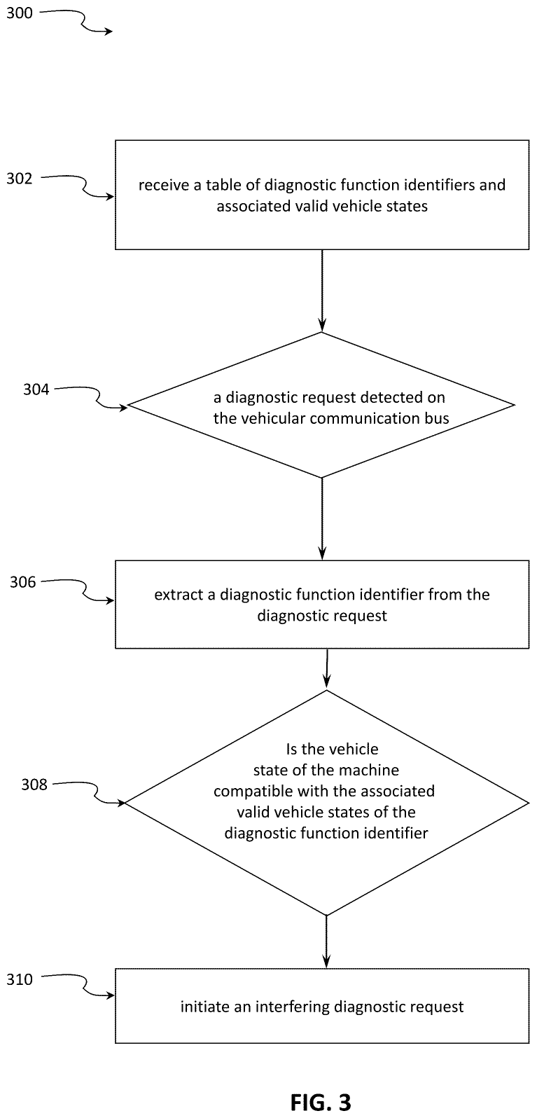

Referring now to the drawings, FIG. 1 is a schematic illustration of an exemplary device for detection and mitigation of diagnostic attacks on machines, according to some embodiments of the present disclosure. An exemplary device 100 may execute processes such as 300, for detecting and mitigating diagnostics based attacks on vehicles or other machines. Further details about these exemplary processes follow as FIG. 3 are described.

The device 110 may include a set of interfaces to a network, as well as other devices and instruments. The interfaces may comprises an input interface 112, and an output interface 114. The device may also comprise one or more processors 122 for executing processes such as 300, and storage 116, comprising a portion for storing code (program code storage 126) and/or memory 124 for data, such as protocol tables, device and/or machine parameters, control scenarios, and/or the like. The device may be physically installed on a stationary machine or a vehicle, implemented as an add-on for another device, implemented using remote communication, on a device connectable using a connector or wirelessly, and/or by several options. The device, or parts thereof, may be implemented on dedicated hardware, FPGA and/or the likes. Further alternatively, the device, or parts thereof, may be implemented on a server, a computer farm, the cloud, and/or the likes. For example, the storage 116 may comprise a local cache on the device, and some of the less frequently used data and code parts may be stored remotely.

The input interface 112, and the output interface 114 may comprise one or more wired and/or wireless network interfaces for connecting to one or more networks, for example, a local area network (LAN), a wide area network (WAN), a metropolitan area network (MAN), a cellular network, the internet, a combination thereof, and/or the like. The input interface 112, and the output interface 114 may further include one or more buses 130. The buses may comprise wired and/or wireless interconnection interfaces, for example, a universal serial bus (USB) interface, a serial port, a vehicular communication bus such as a controller area network (CAN) bus interface and/or the like. Furthermore, the output interface 114 may include one or more wireless interfaces for mitigation of cyber-attacks such as diagnostic attacks, and the input interface 112, may include one or more wireless interfaces for detection of cyber-attacks, receiving information from one or more devices, and the like. Additionally, the input interface 112 may include specific means for communication with one or more sensor devices such as a heat sensor, a gyro meter, or means of user interface such as a microphone, touch screen and/or the like. And similarly, the output interface 114 may include specific means for communication with one or more display devices such as a loudspeaker, a screen and/or the like.

The device may include a module for control functions shown in 120, which may control various electrical or mechanical components such as levers, wheels, gearboxes, heating, cooling, and the like.

The one or more processors 122, may be a homogenous or heterogeneous processing circuitry, and may include one or more processing nodes. The processor may also be a controller specified to fit in machinery, with increased durability to heat, vibrations, abrupt movement, and/or the like. Furthermore, the processor may comprise units optimized for signal processing. The storage 116 may include one or more non-transitory persistent storage devices, for example, a hard drive, a Flash array and/or the like. The storage 116 may also include one or more volatile memory devices, for example, a random access memory (RAM) component, enhanced bandwidth memory such as video RAM (VRAM), and/or the like. The storage 116 may further include one or more network storage resources, for example, a storage server, a network attached storage (NAS), a network drive, and/or the like accessible via one or more networks through the input interface 112, and the output interface 114.

The one or more processors 122 may execute one or more software modules such as, for example, a process, a script, an application, an agent, a utility, a tool, an embedded operating system (OS) and/or the like. The software modules may comprising a plurality of program instructions stored in a non-transitory medium within the program code 126, which may reside on the storage medium 116. For example, the one or more processors 122 may execute a process, comprising detection and mitigation of diagnostic attacks such as 300 the like.

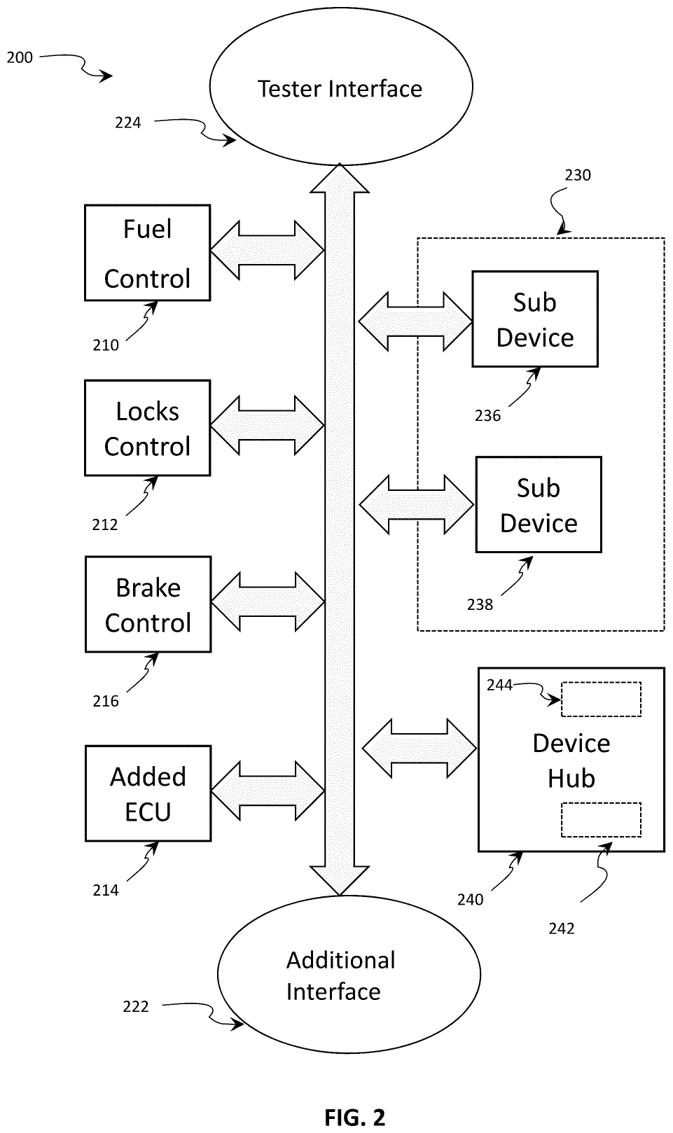

Referring now to, FIG. 2 which is a schematic illustration of an exemplary vehicular communication bus, connected to a plurality of devices, according to some embodiments of the present disclosure.

The vehicular communication bus may form a network may be used for providing a plurality of devices with a platform comprising a plurality of control functions and instructions, for example CAN. The network may allow communication with physical and/or virtual devices, which may perform control functions, such as fuel control shown in 210, locks control shown in 212, dedicated added ECU shown in 214, and brake control shown in 216. The correspondence between virtual control units or nodes and physical machines may be of any positive rational number. For example, the physical machine shown in 230 hosts both virtual sub devices 236 and 238 however, the device hub 240 interfaces both physical devices 242 and 244.

The vehicular communication bus may interface additional devices or the outside network, through a tester interface shown in 224, a gateway, and/or and additional interface shown in 222. Gateways may comprise features such as routing, security, billing, and/or the like however some, or all of these features may also be otherwise implemented on by other devices connected using directly or indirectly to the vehicular communication bus.

Reference is also made to FIG. 3, which is a basic flow chart of an exemplary process detection and mitigation of diagnostic attacks on machines, according to some embodiments of the present disclosure.

The exemplary process 300 may be executed for executing one or more detection and mitigation of diagnostic attacks on machines, for example vehicles, cranes, infrastructure facilities and/or the like. The process 300 may be executed by the one or more processors 122 shown in FIG. 1, located on a dedicated device such as an ECU, or as an additional feature of another device.

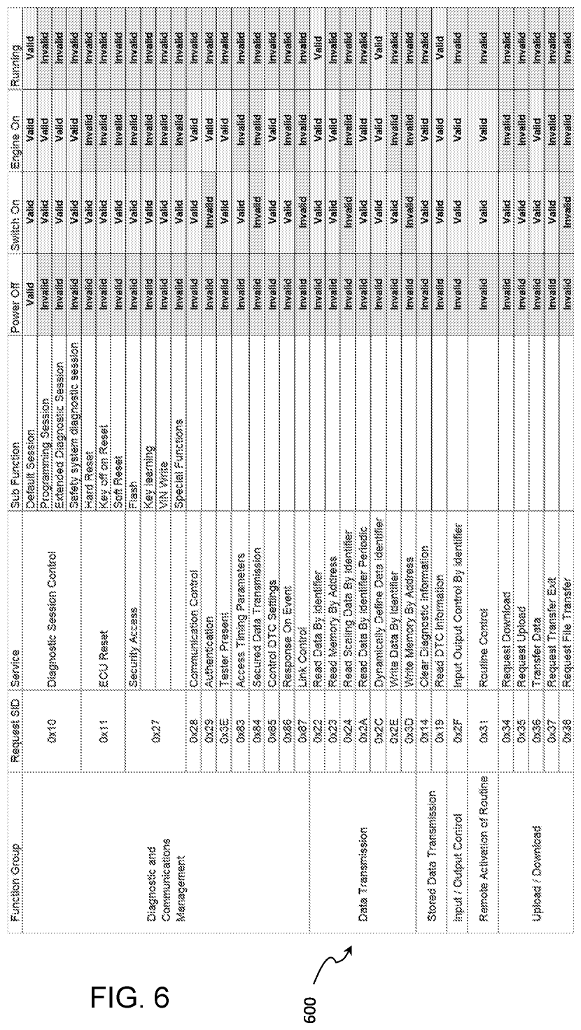

The process 300 may start, as shown in 302 by receiving a table of diagnostic function identifiers and associated valid vehicle states through the input interface 112. In some examples, the table, such as the table shown in FIG. 6, may be stored locally on nonvolatile memory. The table may comprise entries for various messages and commands which may be transmitted through the vehicular communication bus, for example diagnostic requests. The table may be stored on local memory 124 shown in FIG. 1.

The entries may comprise an indication whether a command, instruction, request, and/or the like, is apt to be used in one or more of the possible machine state, which may be referred to as a vehicle state. The vehicle states may be from a list including a state, equivalent to power off, a state, equivalent to switch on without ignition, a state, equivalent stationary with engine on and a state, equivalent to running.

Additional states, such as moving without motor on, states related to one or more additional motors, for example a lateral and a vertical motor of a crane, reverse movement, and/or the like may also be applied.

The exemplary process 300 continues, as shown in 304, with checking when a diagnostic request detected on the vehicular communication bus.

When the vehicular communication bus is not idle, a message may be partitioned, for example ISO-TP message. The part comprising the UDS service identifier (SID), or another identifier of a diagnostic request, may be monitored, as messages are broadcasted over the vehicular communication bus. Alternative protocols may require adaptations apparent to the person skilled in the art.

When the diagnostic request detected on the vehicular communication bus, the processor or device executing the process 300 may continue, as shown in 306 by extracting a diagnostic function identifier from the diagnostic request.

The part comprising the UDS service identifier (SID), or another identifier of a diagnostic request and its sub functions, may be analyzed, to check if a request, not compatible with every vehicle state, was sent to an ECU by another unit. Other protocols may have a different format for diagnostic request, however monitored similarly.

The exemplary process 300 continues, as shown in 308, with checking when the vehicle state of the machine is compatible with the associated valid vehicle states of the diagnostic function identifier.

One method of checking the vehicle state compatibility with the diagnostic function identifier is using a table comprising a Valid/Invalid indication for the diagnostic function identifiers, and the vehicle state. Alternatively, decision trees, software coded rules, and/or the like may be implemented.

The recipient address may be stored for later targeting the ECU or ECUs attacked with an interfering diagnostic request.

And subsequently, when the vehicle state of the machine is incompatible with the associated valid vehicle states of the diagnostic function identifier, the processor or system executing the process 300 may continue, as shown in 310 by initiating an interfering diagnostic request.

When the vehicular communication bus is CAN bus based, and the protocol is UDS, the interfering diagnostic request may be default Session, or ‘ECU Reset’, however other interfering diagnostic requests may be sent to the ECU targeted by the attacker using the vehicular communication bus.

It should be noted that this is an exemplary flow chart of an exemplary process, and variations, adaptations, and the like of the process are apparent to the person skilled in the art, and are within the scope of the claims.

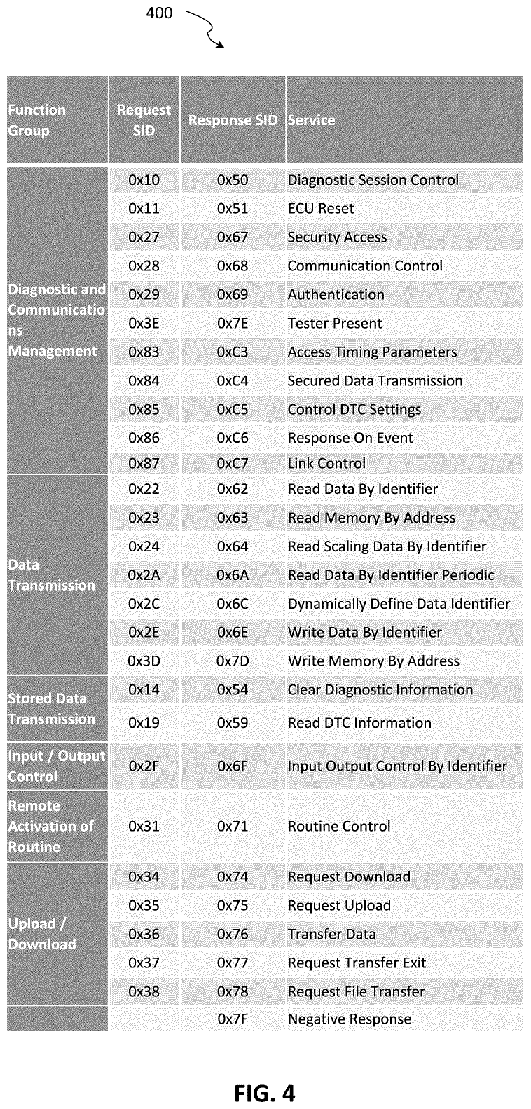

Reference is now made to FIG. 4, which is a table of diagnostic request of an exemplary protocol which may be vulnerable to diagnostic attacks on machines, according to prior art.

Unified Diagnostic Services (UDS) is a diagnostic communication protocol used in electronic control units (ECUs) within automotive electronics, which is specified in the ISO 14229.

‘Unified’ in this context means that it is an international and not a company-specific standard. By now this communication protocol is used in all new ECUs made by Tier 1 suppliers of Original Equipment Manufacturer (OEM), and is incorporated into other standards, such as AUTOSAR. The ECUs in modern vehicles control nearly all functions, including electronic fuel injection (EFI), engine control, the transmission, anti-lock braking system, door locks, braking, window operation, and the like.

Diagnostic tools are able to contact all ECUs installed in a vehicle, which has UDS services enabled. In contrast to the CAN bus protocol, which only uses the first and second layers of the OSI model, UDS utilizes the fifth and seventh layers of the OSI model. The Service ID (SID) and the parameters associated with the services are contained in the 8 data bytes of a message frame.

Modern vehicles have a diagnostic interface for off-board diagnostics, which makes it possible to connect a computer client, or diagnostics tool, which is referred to as tester, to the communication system of the vehicle. Thus, UDS requests may be sent to the controllers which provides a response which may be positive or negative. This makes it possible to interrogate the fault memory of the individual control units, to update the control units with a new firmware, have low-level interaction with their hardware, for example to turn a specific output on or off, or to make use of special functions, also referred to as routines, to attempt to understand the environment and operating conditions of an ECU, and thus be able to diagnose faulty or otherwise undesirable behavior. The UDS service numbers start at 0×10, as shown in the table.

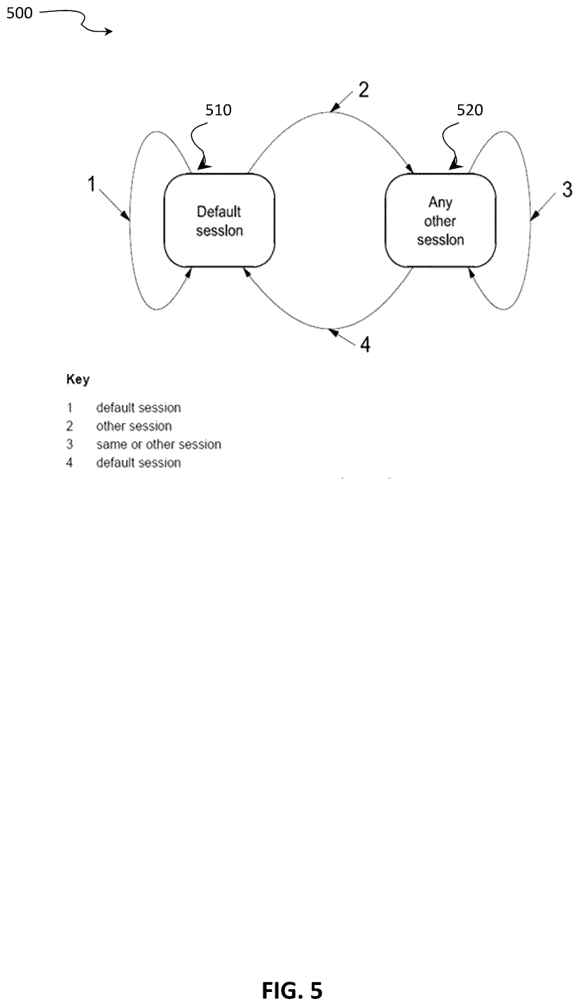

Reference is now made to FIG. 5, which is an exemplary state diagram of an aspect of an exemplary protocol which may be vulnerable to diagnostic attacks on machines, according to prior art.

The Default session is an aspect, shown in 500, which characterizes ECUs in general. All ECUs implementing ISO 14229 have default session that runs services.

UDS may use different operating sessions, which may be changed using the “Diagnostic Session Control”. Depending on which session is active, different services are available. On start, the control unit is by default in the “Default Session” shown in 510. Other sessions are defined, but are not required to be implemented depending on the type of device, and shown generally on 520. Therefore, some ECUs may support “Programming Session” used to upload software, “Extended Diagnostic Session” used to unlock additional diagnostic functions, such as the adjustment of sensors, “Safety system diagnostic session” used to test all safety-critical diagnostic functions, such as airbag tests, and/or the like.

In addition, there are reserved session identifiers that can be defined for vehicle manufacturers and vehicle supplier's specific use. The ECU starts on power up in default session mode.

When sending UDS ‘ECU Reset’ command the ECU restart and goes to Default Session mode. The service “ECU reset” is used to restart the control unit, namely the ECU. Depending on the control unit hardware and implementation, different forms of reset can be used: “Hard Reset” which simulates a shutdown of the power supply, “key off on Reset” which simulates the drain and turn on the ignition with the key, “Soft Reset” which allows the initialization of certain program units and their storage structures, and the like. The defaultSession command may also be used to move an ECU to the “Default Session”.

Reference is now made to FIG. 6, which is an exemplary table of diagnostic function identifiers and associated valid vehicle states of an exemplary protocol which may be vulnerable to diagnostic attacks on machines, according to some embodiments of the present disclosure.

One method of detection is to define a Valid/Invalid diagnostic policy based on the diagnostic command, by the diagnostic function identifiers, and comparing the vehicle state to the valid vehicle states associated with diagnostic function identifiers, for example by the table 600.

Vehicle state is the state of the vehicle which may be one of, for example, the following mode: Power Off, Switch On—Switch is ON without ignition, Engine On—Engine is On but not driving, handbrake is up, and running—The vehicle is driving. Vehicular states may also be assigned to other machines, and other states such as, moving with engine off, using a secondary engine, and the like may also be defined.

Diagnostic request may have a sub function for a specific service, for example, the diagnostic session has a sub function to change to other session such as programming, extended diagnostics, safety system diagnostics sessions. Furthermore, the Security Access request has subfunction to access to Flash, Key learning, VIN write, Special Function and the like.

The Valid/Invalid diagnostic policy reflected in the table is a map of diagnostics request their sub-function and the vehicle state.

When a diagnostic request and Sub Function Vs the Vehicle State is green, or the brighter gray, the Diagnostic operation is Valid.

When a diagnostic request and Sub Function Vs the Vehicle State is red, or the darker grey, the Diagnostic operation is Not Valid.

It should be noted that variants adapted to different protocols, different permission policies, implementations alternative to a table such as decision trees, and the like, are apparent to the person skilled on the art, and are within the scope of the claims.

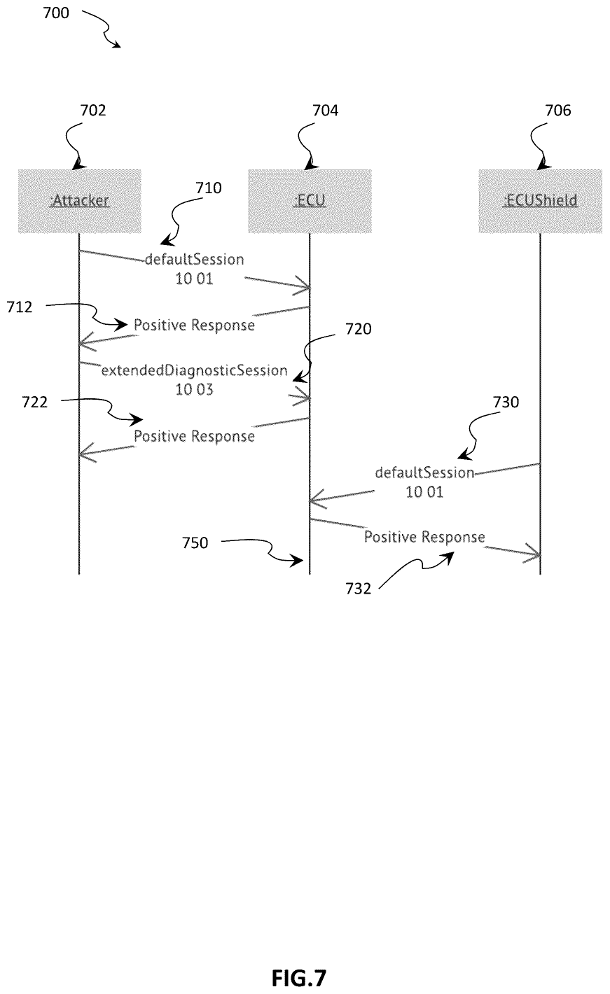

Reference is also made to FIG. 7, which is a sequence diagram of an exemplary process of detection and mitigation of diagnostic attacks on a machine comprising a vehicular communication bus, according to some embodiments of the present disclosure.

The exemplary sequence diagram 700 exemplifies a sequence of detection and mitigation of diagnostic attacks on a machine comprising a vehicular communication bus associated with a process such as 300 (shown in FIG. 3). In this exemplary sequence, the vehicular communication bus supports a controller area network protocol, and the interfering diagnostic request is defaultSession as in UDS, however the disclosure may be applied to similar protocols, sharing the property of diagnostic modes, and compatibility with machine states.

Some implementations of a process sequence of detection and mitigation of diagnostic attacks, may comprise an ECU shown on 704 being attacked by an attacker shown in 702, and an additional device, which is an additional ECU, connected to the vehicular communication bus, namely ECUShield shown in 706. In this example, the device is an ECU, applied by connecting the ECU to the communication bus, however this feature may alternatively or additionally be implemented on an ECU supporting other functions, or an external device connected indirectly to the vehicular communication bus.

The exemplary sequence starts with the first stage of this exemplary attack, shown on 710, wherein the attackers sends a message initializing a diagnostic session through the vehicular communication bus. According to an exemplary protocol of Can bus, namely UDS, the message may be defaultSession, however other protocols may have other messages, sequences thereof, and/or the like. The disclosed method protects the attacked ECU, and the mitigation is applied on the target ECU, rather than on the attacker.

The attacker may, for example, intend to modify and update an ECU with a new software that contains a malicious code. The attacker may apply either an external tool or an internal ECU, which first send commands to the ECU to move to a Programing session mode (request-0×10 SubFunction-0×02).

The attack may be done when the machine is in the vehicular state of running, for example during operation, or driving. The attacked ECU may receive the command and move to ‘Programming Session’ mode. Than the attacker may send additional commands to upload new, malicious software.

The ECU may respond to the first request with an acknowledgement, a positive response, as shown in 712.

Followingly, the attacker may continue with a diagnostic attack, for example extendedDiagnosticSession, as shown in 720. The ECU may respond with an acknowledgement, a positive response, as shown in 722. The ECUshield may follow communication on the vehicular communication bus and extract a diagnostic function identifier from the diagnostic request.

When a not valid diagnostic session is detected by looking up for the diagnostic function identifier in the table, and checking compatibility with the associated valid vehicle states of the diagnostic function identifier, a mitigation method may send an ‘ECU default Session’ command to the appropriate ECU, in response to that diagnostic request, detected on the vehicular communication bus. This command causes the ECU to stop its current session and move back to Default Session state.

The attacker may be unaware of the mitigation, however the command that the attacker may send will be ignored because the ECU is in default session and will not accept other commands that are not applicable to that stare.

Alternative method to mitigate the attack is to use ‘ECU Reset’ command to the attacked ECU. This command causes the ECU to stop its current session by issuing a reset, which may be either hardware, cold or software, warm reset, and thus move to its Default Session mode. Therefore, both ‘ECU default Session’, ‘ECU Reset’ and comparable functions operations, and the likes of other protocols, may be used as an interfering diagnostic request.

Since the machine may be in the vehicular state of running, the ECUShield may send a dafaultSession as shown on 730. The interfering diagnostic request, dafaultSession, is sent in response to a positive response of an ECU to the first diagnostic request whose diagnostic function identifier is other than defaultSession, which is not compliant with the vehicle state of the machine according to the table.

The ECU may respond with an acknowledgement, a positive response, as shown in 732, and revert to the default state, mitigating the attack which may be, for example a reprogramming attempt.

Therefore, the detection of Non-Valid diagnostics session, caused the protector to issue an “ECU Default Session” command. The attacked ECU in response moved back from ‘Programing Session’ mode to ‘Default mode’. Thereby, the attacked ECU to aborted the programming operation and to rejected all other commands that may be sent from the attacker as they are sent not in the correct session mode.

Furthermore, optionally, on detection of diagnostic attack, the vehicle may notify and Alert the machine operator and/or the driver on a possibility of invalid diagnostic session.

In addition, when the machine or the vehicle is connected to a cybersecurity analytic center or any other information center than the vehicle may send Alert to the connected center.

It should be noted that this is an exemplary sequence diagram, and the actual sequence may vary between implementations, attack patterns, and the like.

It is expected that during the life of a patent maturing from this application many relevant vehicular communication buses and diagnostic instructions will be developed and the scope of the terms diagnostic request, diagnostic function identifier, and vehicular communication bus are intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

As used herein the term “method” refers to manners, means, techniques and procedures for accomplishing a given task including, but not limited to, those manners, means, techniques and procedures either known to, or readily developed from known manners, means, techniques and procedures by practitioners of the electrical engineers, software programmers, technicians, and the like.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present disclosure. To the extent that section headings are used, they should not be construed as necessarily limiting. In addition, any priority documents of this application is/are hereby incorporated herein by reference in its/their entirety.

What is claimed is:

1. A method of detection and mitigation of diagnostic attacks on machines comprising a vehicular communication bus, comprising:
receiving a table of diagnostic function identifiers and associated valid vehicle states; and
in response to a diagnostic request detected on the vehicular communication bus:
extract a diagnostic function identifier from the diagnostic request; and
when the vehicle state of the machine is not compatible with the associated valid vehicle states of the diagnostic function identifier, initiate an interfering diagnostic request.

2. The method of claim 1, wherein the vehicular communication bus supports a controller area network protocol, and the interfering diagnostic request is defaultSession.

3. The method of claim 2, wherein the interfering diagnostic request is sent in response to a positive response of an electronic control unit to the first diagnostic request whose diagnostic function identifier is other than defaultSession.

4. The method of claim 2, wherein the method is implemented by an electronic control unit (ECU) and applied by connecting the ECU to the communication bus.

5. The method of claim 1, wherein the vehicle state differ between running and power off.

6. The method of claim 5, wherein the vehicle state comprise a state, equivalent to power off.

7. The method of claim 5, wherein the vehicle state comprise a state, equivalent to switch on without ignition.

8. The method of claim 5, wherein the vehicle state comprise a state, equivalent stationary with engine on.

9. The method of claim 5, wherein the vehicle state comprise a state, equivalent to running.

10. A device for detection and mitigation of diagnostic attacks on machines comprising a vehicular communication bus, comprising at least one processing circuitry configured to:
receive a table of diagnostic function identifiers and associated valid vehicle states; and
in response to a diagnostic request detected on the vehicular communication bus:
extract a diagnostic function identifier from the diagnostic request; and
when the vehicle state of the machine is not compatible with the associated valid vehicle states of the diagnostic function identifier, initiate an interfering diagnostic request.

11. The device of claim 10, wherein the vehicular communication bus supports a controller area network protocol, and the interfering diagnostic request is defaultSession.

12. The device of claim 11, wherein the interfering diagnostic request is sent in response to a positive response of an electronic control unit to the first diagnostic request whose diagnostic function identifier is other than defaultSession.

13. The device of claim 11, wherein the device is an electronic control unit (ECU) and applied by connecting the ECU to the communication bus.

14. The device of claim 10, wherein the vehicle state differ between running and power off.

15. The device of claim 14, wherein the vehicle state comprise a state, equivalent to power off.

16. The device of claim 14, wherein the vehicle state comprise a state, equivalent to switch on without ignition.

17. The device of claim 14, wherein the vehicle state comprise a state, equivalent stationary with engine on.

18. The device of claim 14, wherein the vehicle state comprise a state, equivalent to running.

19. A computer program product comprising instructions of mitigation of diagnostic attacks on machines comprising a vehicular communication bus, wherein execution of the instructions by one or more processors of a device is to cause the device to:
receive a table of diagnostic function identifiers and associated valid vehicle states; and
in response to a diagnostic request detected on the vehicular communication bus:
extract a diagnostic function identifier from the diagnostic request; and
when the vehicle state of the machine is not compatible with the associated valid vehicle states of the diagnostic function identifier, initiate an interfering diagnostic request.
